(19) United States
(12) Patent Application Publication
(10) Pub. No.: US 2016/0324207 A1
(43) Pub. Date: Nov. 10, 2016

(54) EDIBLE MATERIAL

(71) Applicants: Chelsea Fawn Briganti, Beacon, NY (US); Leigh Ann Tucker, Warwick, NY (US)

(72) Inventors: Chelsea Fawn Briganti, Beacon, NY (US); Leigh Ann Tucker, Warwick, NY (US)

(73) Assignee: LOLIWARE LLC, Beacon, NY (US)

(21) Appl. No.: 15/192,254

(22) Filed: Jun. 24, 2016

Related U.S. Application Data
(63) Continuation of application No. PCT/US2016/027474, filed on Apr. 14, 2016.
(60) Provisional application No. 62/235,968, filed on Oct. 1, 2015.
(60) Provisional application No. 62/147,937, filed on Apr. 15, 2015.

(51) Int. Cl. A47G 21/18

(52) U.S. Cl. CPC A23P 30/10; A23L 29/256; A23L 29/30; A23L 19/11; A23P 20/10

(57) ABSTRACT

An edible material may be made of liquid, sugar, and one or more hydrocolloids. The edible material may be used to form edible cups, containers, and the like and may be capable of holding hot or cold liquids for extended periods of time, and have an extended shelf life. The composition forming the edible material may further be suitable for 3D printing 3D edible applications.

### CLAIM OF PRIORITY

This application claims priority to PCT/US2016/027474 filed on Apr. 14, 2016 claiming priority to U.S. Application 62/235,968 filed on Oct. 1, 2015 and U.S. Application 62/147,937 filed on Apr. 15, 2015, the contents of all of which are herein fully incorporated by reference in its entirety.

### FIELD OF THE EMBODIMENTS

The present invention and its embodiments relate to edible objects made from an edible material(s). The edible objects may include but are not limited to containers for holding hot or cold liquids to be consumed, straws, lids, utensils, containers for the table top, clothing, beverage drops, food wraps, and packaging. The material can also be used for 3D printing 3D edible applications. The present invention and its embodiments further relates to an edible material made from natural ingredients. The edible material can be used to form edible containers holding hot or cold liquids for extended periods of time. It may have an extended shelf life, and is sturdy enough to be used for a variety of applications.

### BACKGROUND OF THE EMBODIMENTS

There are many types of disposable utensils, and packaging that are used on a daily basis. Such items are typically made from paper, plastic, Styrofoam® foam, etc. These materials are not usually biodegradable. A biodegradable material that is also edible material is a better alternative for making disposable containers, packaging, and other objects. Edible containers made from edible material(s) do not produce harmful waste and are thus environmentally friendly. Biodegradable, edible materials are an environmentally conscious solution which reduces waste.

In order to be an effective substitute, the edible material must be able to withstand the hot and cold temperatures of food and beverages. In particular, given the large consumer demand of coffee and other beverages, cups made from an alternative edible material must be able to hold both hot and cold liquids. While several examples of edible containers exist today, most lack the structural integrity and versatility required to hold liquids having different temperatures. The most common types of edible containers today are ice cream cones, which are made from baked dough. These cups are made by pouring batter into a mold and then baking. While coating the dough cup with a waterproof layer, as described by U.S. Pat. No. 6,068,866 to Petrini, may allow it to hold liquids without leaking, the dough cup still faces structural integrity challenges. Because of the brittle nature of baked dough and its tendency to become stale, the resulting edible cup is not very durable as it tends to break or get soggy, is limited to certain usage scenarios, and has a limited shelf life.

Woods et al. (U.S. Pat. No. 6,423,357) pertains to an edible container that can hold and contain medium and low viscosity liquids for extended periods of time. One embodiment of the present invention comprises an edible dehydrated food sheet formed into a vessel capable of holding liquid for extended periods of time without leakage and capable of being hand-held, an opening in said container for receiving liquids, and a flat base capable of stabilizing said container in an independent upright position. The dehydrated food sheet may be formed from dehydrated fruit or dehydrated vegetable material.

Baumann et al. (U.S. Pat. No. 5,840,354) pertains to improved, intermediate moisture sweetened fruit compositions fortified with calcium supplied by calcium phosphate. The fruit compositions comprise: A) about 5 to 65% by weight of fruit solids; B) about 0.1 to 85% of carbohydrates; C) about 180 to 1500 mg/oz. total calcium; and D) about 9 to 20% moisture. Also disclosed are methods for the preparation of such fruit products involving forming a concentrated slurry of calcium phosphate having a particle size such that at least 90% are less than 150 μm forming a wet blend of fruit ingredients, drying the wet blend to 9 to 20% moisture and admixing the dried fruit composition while warm with the slurry to form a dried sweetened calcium composition and forming into desired shaped and sized pieces.

Langler (U.S. Pat. No. 4,853,236) pertains to improved, dual textured food products comprising a portion of one texture and a second portion of a different texture that exhibits enhanced shelf life stability. Preferred food products are fruit snack pieces comprising a soft, supportive, fruit-containing shell portion and a second, more fluid, variably textured core portion. The shell portion can comprise a dehydrated fruit puree composition. The core portion comprises an o/w emulsion to create a hydrophobic, liquid-fat barrier between the portions.

Emsing et al. (U.S. Pat. No. 6,783,790) pertains to a continuous process for making a high solids confectionery product containing agar-agar using high temperature short time processing. The process comprises (a) preparing a homogenous mixture comprising agar-agar, an agar-agar dispersing agent in an amount sufficient to disperse and suspend the agar-agar to control hydration when in contact with water and heat, a sweetening effective amount of a sweetener, and water, said homogenous mixture containing a solids content ranging from about 60% to about 80% by weight solids; (b) feeding the homogenous mixture of step (a) to a heating apparatus having an inlet and outlet with heating means interposed therebetween, and subjecting said mixture to a high temperature short time continuous process under conditions sufficient to cook and concentrate the mixture and to evaporate the water to form water vapor; (c) removing the formed water vapor formed in step (b); and (d) cooling said mixture, thereby forming a high solids confectionery product, all of said steps (a), (b) (c) and (d) being conducted in a continuous process.

Another approach is to make an edible material from dehydrated fruits or vegetables. U.S. Pat. No. 6,423,357 to Woods pertains to an edible container made of dehydrated fruit or vegetable formed into strips and wrapped around a mandrel. While this edible container may hold and contain low viscosity liquids for extended periods of time, the dehydrated fruit and vegetable is susceptible to rehydration when in contact with a liquid. Additionally, cups such as these suffer from both the strength limitations of the dehydrated fruit or vegetable and the difficulty in forming the dehydrated material into a cup shape. These containers also face the problem of a limited shelf life.

Accordingly, there is a need for an improvement over existing disposable containers that are edible and biodegradable. A more versatile, edible material may provide a solution, since it may easily be molded into a variety of shapes, can hold hot and cold liquids for extended periods of time without losing its structural integrity, and has reasonable shelf life.

### SUMMARY OF THE EMBODIMENTS

The present invention and its embodiments comprise a composition suitable for being processed into an edible material. In one embodiment of the present invention, the composition comprises water, syrup, sugar and one or more hydrocolloids, wherein the syrup is present in an amount of about 25% to 45% by weight pre-process, the sugar is present in an amount of about 20% to 40% by weight pre-process, and the hydrocolloid is present in the amount of about 1% to 10% by weight pre-process.

In another embodiment of the present invention there is a composition comprising: water, syrup, sugar; and one or more hydrocolloids; wherein the syrup is present in an amount of about 30% to about 45% by weight, the sugar is present in the amount of about 20% to about 35% by weight, and the one or more hydrocolloids is present in the amount of about 1% to about 5% by weight.

In another embodiment, there is an edible material having a composition of water, syrup, sugar and hydrocolloid, where the composition is processed into an edible material; and an edible coating covering at least a portion of the edible material.

In another embodiment, the invention is a method for making an edible material comprising the steps of combining water, syrup, sugar, and one or more hydrocolloids into a mixture; processing the mixture into an edible object by heating the mixture until the sugar and the hydrocolloids are dissolved, pouring the mixture into a mold, cooling the mixture, de-molding the edible object, and dehydrating the edible object until water is present in the amount of about 2% to about 20% by weight. The invention also encompasses edible materials and edible objects made by this method.

The present invention and its embodiments further relate to an edible material made from natural ingredients including liquids, sugar, and hydrocolloids. In one embodiment, the edible material forms an edible container, capable of holding hot or cold food products including liquids for extended periods of time. Additionally, it may be used to form edible packaging, food wraps, dissolvable beverage drops, frozen foods, clothing, toys, table-top containers and accessories, and 3D printing material. In one embodiment, the edible material is made by combining the liquid, sugar, and hydrocolloid, heating the mixture to dissolve the sugar and to set the agar, pouring the heated mixture into a mold so as to allow the mixture to harden, cooling the mixture until the mixture is firm and molded into an edible object, de-molding the edible object, dehydrating the edible object to reduce the water concentration in the edible object, and coating the exposed surfaces of the edible object with an edible coating. In another embodiment, the edible material forms a container that is coated with an edible coating, which not only enables the container to be waterproof but, also extends the shelf life of the container.

It is an object of the present invention to create an edible material useful for comprising a variety of edible objects.

It is an object of the present invention to provide an edible material capable of having an extended shelf life.

It is an object of the present invention to provide an edible material that is flavored and/or colored.

It is an object of the present invention to provide an edible material in the form of a beverage receptacle.

It is an object of the present invention to provide an edible material that can adequately hold both hot and cold beverages.

### BRIEF DESCRIPTION OF THE DRAWINGS

FIG. 1 is a flow diagram illustrating a process of making an edible material according to certain embodiments.

### DETAILED DESCRIPTION OF THE EMBODIMENTS

The disclosed embodiments are directed to edible materials for molding into edible and biodegradable object such as containers, films and wraps, dissolvable beverage infusion drops, packaging, clothing, toys, and edible material for 3D printing. Edible materials may form objects that are then coated with an edible coating that allows an edible object formed of the edible material to be waterproof, hold hot and cold liquids for extended periods of time, and have an extended shelf life of twelve months or more.

In some embodiments, the edible material is made of natural materials that are safe to eat and a delicious alternative to a non-biodegradable material that would otherwise be destined for a landfill. The edible material may include liquids, syrup, sugar, and one or more hydrocolloids. Examples of preferred hydrocolloids are agar, carrageenan and pectin. Additional ingredients such as citric acid may also be used. In some embodiments, the edible material is made of water, syrup, sugar, and agar. The specific types of liquids, syrups, sugars, and hydrocolloids that may be used to make the edible material are described in the following sections.

### Water-Based Liquid

As used herein, a water-based liquid is any edible, water-based liquid with low viscosity. According to some embodiments, water such as filtered water, distilled water, purified water, spring water, and mineral water may be used. Additional water-based liquids that may be used are juice, juice concentrate, cane juice, milk, invert sugar, treacle, any alcohol, energy drinks, caffeinated coffee, decaffeinated coffee, caffeinated beverages, carbonated beverages, such as soda or sparkling waters, nut milks, coconut milk, flavored milks, alkaline water, purified waters, flavored waters, teas, tea infusions, hot chocolate, ciders, cold-pressed juices, sports drinks, coconut water, fermented liquids, such as kombucha and kvass and herbal infusions. According to certain embodiments, a water-based liquid has a dynamic viscosity of less than 100 centipoise (cps) at room temperature. In some embodiments, water-based liquid has a dynamic viscosity of less than 10 cps or less than 5 cps at room temperature. For example, a water-based liquid may be water with dynamic viscosity of around 1 cps at room temperature. As another example, a water-based liquid may be milk with dynamic viscosity of around 3 cps at room temperature.

### Syrup

Any edible syrup may be used. In general, a syrup is a thick, viscous liquid consisting primarily of a solution of sugar in water, containing a large amount of dissolved sugars but showing little tendency to deposit crystals. Syrups can be made by dissolving sugar in water or by reducing naturally sweet juices such as cane juice, sorghum juice, or maple sap.

In some embodiments, an organic, gluten-free, non-GMO (genetically modified organisms) syrup such as tapioca syrup, agave syrup or nectar, brown rice syrup, maple syrup, sorghum syrup, sugar cane syrup, and beet syrup is used. Non-GMO, gluten-free syrups such as tapioca syrup provide healthier options for people with food allergies or food sensitivities. Tapioca syrup, in a preferred embodiment, provides a healthier alternative to corn syrup while preserving the sweet flavor. Other syrups may include rice syrup, tapioca syrup, agave (syrup or nectar), golden syrup, malt syrup, simple syrup (any other sugar and water mixture), fruit and herbal flavored syrups, such as rose syrup, mint syrup, date syrup, sour cherry syrup, almond syrup and jelab syrup, barley malt syrup, birch syrup, honey, raw honey, palm syrup, sorghum syrup, sugar beet syrup, and yacon syrup. Other syrups may be chocolate syrup, coconut syrup, maple syrup, carob molasses, any fruit flavored molasses, such as grenadine molasses, grape molasses and pomegranate molasses. According to certain embodiments, a syrup has a dynamic viscosity above 1000 cps at room temperature. According to certain embodiments, a syrup has a dynamic viscosity above 100 cps at room temperature.

### Sugar

Sugar is the generalized name for sweet, short-chain, soluble carbohydrates, many of which are used in food. There are various types of sugar derived from different sources. Simple sugars are called monosaccharides and include glucose (also known as dextrose), fructose and galactose. The table or granulated sugar most customarily used as food is sucrose, a disaccharide. (In the body, sucrose hydrolyses into fructose and glucose.) Other disaccharides include maltose and lactose. Longer chains of sugars are called oligosaccharides. While any form of sugar may be used, evaporated cane juice crystals, such as Wholesome Sweeteners Brand Evaporated Cane Juice Crystals, is used in a preferred embodiment. Other sugars that may be used are sucrose, glucose, dextrose, lactose, maltose, xylose, fructose, and galactose. Sucrose is a disaccharide also called saccharose comprised of 50% fructose and 50% glucose. Types and names of sucrose are white sugar, castor sugar, table sugar, cane sugar, cane crystals, cane juice crystals, evaporated cane juice crystals, yellow sugar, golden sugar, demerara sugar, muscovado sugar, turbinado sugar, brown sugar, beet sugar, and date sugar. Glucose is a simple sugar, or monosaccharide. Types and names of glucose are D-glucose, dextrose, corn sugar, and grape sugar. Fructose is a simple sugar, or monosaccharide, found in fruits. Types and names of fructose are fruit sugar and crystalline fructose. Galactose is also a simple sugar, or monosaccharide. In one preferred embodiment, organic Fair Trade Cane Sugar is used.

### Hydrocolloid

A hydrocolloid is a substance that can gel when combined with water and is defined as a type of mechanical mixture where one substance is dispersed evenly throughout a water-containing liquid. Many hydrocolloids can change their physical behavior and characteristics with the addition or elimination of heat and have the ability to thicken and form gels at low concentrations. Hydrocolloids are generally polysaccharides (complex sugars), and when dissolved in water, forms a layer of water with restricted movement as a result of the water being attracted to the sugar molecules. This restriction of water movement gives hydrocolloids their ability to gel. Different hydrocolloids have different physical properties and different chemical properties such as molecular size, charge, and the distribution and composition of different side chains along the main sugar chain. These differences result in different gelling behaviors. Types of hydrocolloids include agar, pectin, carrageenan, gelatin, corn starch, gellan gum, guar gum, gum arabic, isomalt, konjac, lecithin, locust bean gum, maltodextrin, methylcellulose, sodium alginate, xanthan gum, and tapioca.

### Agar

Agar, also referred to as agar-agar, is a hydrocolloid and a natural vegetable counterpart to animal-derived gelatin. Agar is a flavorless gelling agent derived from a polysaccharide in red algae, where it accumulates in the cell walls. In chemical terms, agar is a polymer made up of subunits of the sugar galactose. The primary source for this substance is gracilaria lichenoides. To extract the substance, the algae is boiled, cooled, purified, and dried. Agar is commonly used as an ingredient in desserts and as a vegetarian gelatin substitute. Pure agar comes in a number of forms including blocks, flakes, and granules. It is usually translucent, unless it has been dyed before drying.

### Citric Acid

Citric acid is a natural preservative used to add an acidic, or sour taste to foods and soft drinks. Usually produced in powder form, citric acid is naturally found in citrus fruits. It easily mixes into liquids, making it a valuable acid. Citric acid is a weak organic acid that bonds easily to minerals and metals. Alternatives such as lemon juice, lemon powder, ascorbic acid, tartaric acid, malic acid, and sour salt may also be used. Citric acid used herein may be available from suppliers such as but not limited to Cargill and MBFerts.

### Coloring Agents

Coloring agents may be used to color the edible material. Preferably the coloring agent is oil or water soluble and present in the composition in the amount of about 0.1% to about 10% by weight, however, some embodiments may be devoid of any coloring agent. Representative coloring agents are available from DDW Color House, Food Ingredient Solutions, GNT, Natural Flavors Inc., and Sensient Food Colors. Depending on the coloring agent or agents chosen, the edible cups may be translucent, opaque, or completely clear and colorless.

### Flavoring Agents

The edible material may also include a flavoring agent. Flavoring agents suitable for the invention may be derived from natural and/or synthetic sources such as plants, herbs, spices, animals, microbial fermentations, esters, aldehydes, ketones, and the like. Representative examples of flavoring agents are available from Abelei, The Tec Team, Virginia Dare, Silesia, Carmi Flavors, Fruit D'Or, American Fruit Flavors, Lakewood Organic, and Comax Flavors and are present in about 0.1% to about 10% by weight. In some embodiments, no flavoring agents are used. Various flavoring agents may include but are not limited to yuzu, grapefruit, cherry, matcha green tea, vanilla, chocolate, raspberry, strawberry, cranberry, passionfruit, apple, blueberry, papaya, lemon, lime, champagne, grape, banana, watermelon, honey, peach, orange, kiwi, pomegranate, plum, coconut, and the like or any combination thereof.

### Coating

The edible material may be coated in a wax-based edible coating to make the material waterproof and to extend shelf life. For some edible objects, the coating may reduce the stickiness of the edible material. In one embodiment, the edible coating is made from vegetable oils, alcohols including but not limited to ethanol, oils including but not limited to coconut oil, palm oil, beechnut oil, castor oil, cottonseed oil, groundnut oil, hazelnut oil, olive oil, palm kernel oil, peanut oil, peel oil, poppy oil, black current seed oil, flaxseed oil, amaranth oil, apricot oil, raisin seed oil, rapeseed oil, rice bran oil, safflower oil, sesame oil, sunflower seed oil, tucum oil, soybean oil, almond oil, brazil nut oil, cashew oil, macadamia oil, mongongo nut oil, pine nut oil, pistachio oil, and walnut oil, short or medium or long chain triglycerides, isopropanol, monoglycerides, diglycerides, confectioner's glaze, acetone, acetylated monoglycerides, beeswax, and shellac. The edible coating is made, in some embodiments, by mixing the ingredients until they have a liquid consistency. In one embodiment where the edible material is used to form an edible container, the edible coating may be applied to the edible container after the edible container been molded and dried. The coating may be applied by spraying, dipping, brushing or otherwise applied to the inner and/or outer surfaces of the container to make the container waterproof.

### Other Ingredients

The edible material may also include, for example, agave powder, stevia, dextrose, maltodextrin, agave nectar, barbados sugar, barley malt, crystalline fructose, dextrin, dextran, d-mannose, glucose solids, honey, lactose, maltose, mannitol, maple syrup, sorbitol, liquid and powdered vitamins, minerals, electrolytes, caffeine, pieces gelled inside the gel like flower petals, plant seeds, candies, sprinkles, any edible decorations, edible gold and silver, chocolate pieces, coconut flakes, fibers, cereals, dehydrated fruit, dehydrated vegetables, herbs, nuts, seeds, and edible confetti.

### Embodiments

According to certain embodiments, the edible material is made from a water-based liquid, syrup, sugar, and agar. According to certain embodiments, the edible material is made from a pre-process (i.e. the starting material prior to beginning the process of making the edible material) mixture of about 25%-50% by weight syrup, about 25%-45% by weight sugar, and about 0.5%-5% by weight agar and the rest water. According to certain embodiments, the edible material is made from a pre-process mixture of about 25%-35% by weight water-based liquid, about 28%-35% by weight syrup, about 30%-40% by weight sugar, and about 1%-3% by weight agar.

According to certain embodiments, the edible material is made from a pre-process mixture of about 28%-30% by weight water-based liquid, about 29%-33% by weight syrup, about 33%-38% by weight sugar, and about 1.5%-2.5% by weight agar. According to certain embodiments, the edible material is made from a pre-process mixture of about 29% by weight water-based liquid, about 31% by weight syrup, about 36% by weight sugar, and about 2% by weight agar. According to certain embodiments, the edible material is made from a pre-process mixture of about 28.5%-29.5% by weight filtered water, about 30.5%-31.5% by weight tapioca syrup, about 35.5%-36.5% by weight cane sugar, and about 1.8%-2.2% by weight agar.

During the process of making the edible material, water may be lost to evaporation (e.g., by cooking/boiling and/or by natural or forced drying). Therefore, the water content by weight in the post-cooking form of the edible material may be less than the pre-process water content by weight. In some embodiments, up to 35% of the pre-process water amount (i.e., the water portion of the water-based liquid) is lost. In some embodiments, from about 15%-30% of the pre-process water amount is lost. In some embodiments, from about 20%-28% of the pre-process water amount is lost. In some embodiments, from 22%-25% of the pre-process water amount is lost. According to certain embodiments, the post-cooking water loss described above reflects the final water content of the edible material. According to certain embodiments, the post-cooking water amount described above reflects the final water content of an edible object made from the edible material.

Various properties of several formulations of the edible material are contained in Table 1 below.

TABLE 1

| | Moisture (%) | | | | | |
|---|---|---|---|---|---|---|
| Formulation | Post Cook | Initial Serving Size (g) | Dried Cup Weight (g) | Post Dry % Moisture | Calories | Post Cook Brix |
| 1 | 31.66 | 93.10 | 73.94 | 13.92 | 242.87 | 69.00 |
| 2 | 25.66 | 93.34 | 74.47 | 6.79 | 259.73 | 75.00 |
| 3 | 33.67 | 92.43 | 71.88 | 14.66 | 234.51 | 70.00 |
| 4 | 31.74 | 92.87 | 74.60 | 15.01 | 242.60 | 71.00 |
| 5 | 31.69 | 92.81 | 74.38 | 14.70 | 242.02 | 70.00 |
| 6 | 31.14 | 93.20 | 76.02 | 14.18 | 244.46 | 70.00 |
| 7 | 32.13 | 92.13 | 73.72 | 15.17 | 238.82 | 70.00 |
| 8 | 31.14 | 91.13 | 74.06 | 11.40 | 239.05 | 72.00 |
| 9 | 31.86 | 89.85 | 70.88 | 13.65 | 234.55 | 72.00 |
| 10 | 30.19 | 92.88 | 75.24 | 13.81 | 246.87 | 69.00 |

As shown in Table 1, various formulations of the edible material were produced under varying conditions, such as ingredients, and were measured for at least their moisture content (pre-drying), initial serving size, dried weight or dry serving size, moisture content (post-drying), calories, and brix. The brix may range for the formulations from between about 60 to about 80 and is more preferably about 65 to about 75. None of the above 10 formulations (formula 1 at top of table and formula 10 at bottom) were found to exhibit or display crystallization up to six days after ambient storage. However, some crystallization is seen in most formulations after both 2 and 4 weeks' time frame. In turn, formulations 3, 9, and 10 exhibited very little change in firmness, taste, and crystallization after up to 5 weeks since production and storage. However, the embodiments shown in the above Table are intended to be exemplary only and other embodiments may exist in the same or differing proportions of each specified material and other materials not specifically specified herein.

According to certain embodiments, the mouth feel of an edible material according to certain embodiments is soft candy-like (e.g., as opposed to brittle gel-like). According to certain embodiments, the edible material can be used to form edible objects with high structural integrity (e.g., above 95%). According to certain embodiments, the edible material can be used to form edible objects with high structural integrity (e.g., above 95%) with low wall thicknesses.

In one embodiment, the edible material is used to form an edible cup. The edible nature of the cup allows it to be eaten as the drink it contains is sipped. The edible cup may be used at parties and events in place of disposable cups or in other contexts where disposable cups would normally be used. The edible cup may also be molded into different shapes. In one embodiment, the edible cup may have an indented outer surface that allows a sleeve to be snugly placed around the cup. In addition to cups, the edible material may be used to form other containers, straws, lids, utensils, and other table top containers using the same ingredients. In some embodiments, the edible cup may contain low viscosity liquids such as water, fruit juice, milk, alcoholic beverages, coffees, teas, sports drinks, sodas, and other drinks for extended periods of time without degrading.

According to certain embodiments, the edible cup may contain low viscosity liquids with dynamic viscosities below 100 cps at room temperature. According to certain embodiments, the edible cup may contain low viscosity liquids with dynamic viscosities below 10 cps at room temperature. According to certain embodiments, the edible cup may contain a low viscosity liquid (e.g., water with a dynamic viscosity near 1 cps at room temperature) for up to 72 hours or more without degrading (e.g. while still maintaining structural integrity and not leaking). The edible cup can also hold liquids containing ice. Depending on the formulation, the edible cup may contain liquids ranging from 32 to 180 degrees Fahrenheit. The ideal holding time for cold and hot liquids is at least one hour. According to certain embodiments, an edible cup or container may contain low viscosity liquids over 160 degrees Fahrenheit, for 30-60 minutes, preferably for 6 hours or more. In other embodiments the edible container may be suitable for containing liquids for 30-60 minutes, preferably for 2 hours or more.

Adjusting the ingredients used to make the edible cup can produce different durometers (hardness), textures, and other properties. The edible cup according to one embodiment is made to look like a real glass cup. According to certain embodiments, an edible cup has structural integrity over 50%. According to certain embodiments, an edible cup has structural integrity over 80%. According to certain embodiments, an edible cup has structural integrity over 90%. According to certain embodiments, an edible cup has structural integrity over 95%. According to certain embodiments, an edible cup has a low wall thickness while maintaining high structural integrity. According to certain embodiments, the high structural integrity allows the cup to be molded with more defined patterns and sharp edges. According to certain embodiments, the low wall thickness improves the translucency of the edible cup. According to certain embodiments, the cups may comprise varying sizes, shapes, and patterns formed surfaces thereof.

The cups may have varying coloring and/or flavoring added, which may include but is not limited to, opaque white (colored with International Foodcraft Corporation #CD 801—White Shade Dispersion “A”) with vanilla flavoring (flavored with Frontier Non-Alcoholic Vanilla Flavor for vanilla), translucent orange (colored with GNT EXBERRY® Shade “Summer Red” Product No: 843301+Color Maker Natural Saffron Yellow Color Formula No. 3635C) with pepper flavoring (flavored with Mutual Flavors J01430 Jalapeno Flavor Natural), translucent yellow (colored with Color Maker Natural Saffron Yellow Color Formula No. 3635C) with lemon flavoring (flavored with Mutual Flavors L02830 Lemon Flavor O.S. Natural WONF), translucent red (colored with GNT EXBERRY® Shade “Summer Red” Product No: 843301) with bitters flavoring (flavored with Mutual Flavors 541130 Bitters Spice Blend Flv Type O.S., NAT) for bitters, and translucent green (colored with World Organic Liquid Chlorophyll) with lime flavoring (flavored with Mutual Flavors L36530 Lime Flavor Natural). The bottoms are preferably flat and the sides are preferably slightly tapered with designs molded into the outside. Notably, these edible cups look like a regular glass cup with a cut glass pattern.

As described, the edible material may be made with various concentrations of water, sugar, and hydrocolloids to produce a material with various flexibility, hardness, and other textures. In one embodiment, the edible material is made from a starting solution comprising 24% to 72% mass percentage of water, 5% to 48% mass percentage of sugar, and 1% to 10% mass percentage of hydrocolloids. In another embodiment, edible cups may also be made with a starting solution comprising 25% to 76% mass percentage of water, 5% to 41% mass percentage of sugar, 0.2% to 2.5% mass percentage of agar, 1.2% to 5.1% mass percentage of carrageenan, and 0.1% to 2.8% mass percentage of pectin. In another embodiment, the edible cup comprises a starting solution 67.22% by weight of water, 27.94% by weight of sugar, 0.70% by weight of vegetable glycerin, 0.78% by weight of agar, 2.65% by weight of carrageenan, 0.40% by weight of pectin, 0.03% by weight of CaCl2, and 0.28% by weight of citric acid. In one embodiment, the edible cup is made from 120 ml of liquid, 73 grams of sugar, and 15 grams of hydrocolloids.

In another embodiment, the edible material is made from a solution that makes enough edible material for a ten cup batch of edible cups. The pre-process mixture comprises 410 grams of water (29% mass percentage), 440 grams of organic tapioca syrup (31% mass percentage), 510 grams of organic Fair Trade cane sugar (36% mass percentage), and 33 grams of agar (2% mass percentage) prior to cooking.

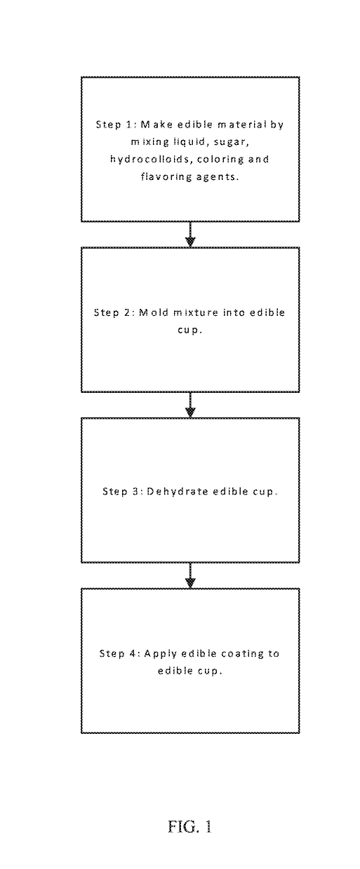

The method for making the edible material of this embodiment is described in FIG. 1. The method includes a first step of combining the liquid, the sugar, and the hydrocolloids, boiling the mixture for five minutes to dissolve the ingredients and set the hydrocolloids. The mixture is then cooled down to about 120° F. to about 240° F. and more preferably about 194° F. Color agents and flavoring agents are then mixed in. Once the mixture is ready, in step 2, the mixture is poured into a dispensing device used for molding the edible material into edible cups. As a result of the cooking process, approximately 101 grams of water is lost to evaporation. Each edible cup may be made from about 5 grams to about 200 grams of the mixture.

In one embodiment, about 98 grams is dispensed into a first part of the mold. A second part of the mold is then inserted into the first part of the mold in order to imprint a pattern on the outer surface of the cup. The two mold parts are aligned and snapped together to form a cup. The process of making the molds is described in a further section. The mixture is allowed to set in the mold for one to two hours, before the edible cup is removed from the mold. Once the molded cup has cooled, it is placed into a dehydrator as shown in step 3. The edible cup is dehydrated for about one hour to about twenty-four hours, and more preferably about four hours to about eight hours. After dehydration, the edible cup is cooled for another hour before coating. In step 4, the edible cup is coated with a wax-based coating. Once coated, the edible cup is cooled with fans for another about one hour to about twenty-four hours and more preferably about two hours to about twelve hours. The proportions of the ingredients may be modified as well as the amount of water lost from evaporation and dehydration to achieve different desired flexibility of the edible material. Other embodiments may contain 50 ml to 150 ml of liquid, 10 g to 100 g of sugar, and 2 g to 20 g of hydrocolloids in pre-process weight.

In another embodiment, the edible cup is made from 120 ml of liquid, 62 g of sugar, 4 g of agar, 8 g of carrageenan, and 4 g of pectin. The method for making the cup of this embodiment includes combining the liquid, the sugar, the agar, the carrageenan, and the pectin, heating the mixture to dissolve the ingredients and set the hydrocolloids, and molding the mixture and allowing it to set. The amounts of these ingredients may be modified to achieve different desired properties. Other embodiments may contain 50 ml to 150 ml of liquid, 20 g to 80 g of sugar, 0.5 g to 5 g of agar, 2.5 g to 10 g of carrageenan, and 0.25 g to 5.5 g of pectin in pre-process weight. In another embodiment, the edible cup is made from 240 ml of water, 100 g of sugar, 2.5 g of vegetable glycerin, 2.8 g of agar, 9.5 g of carrageenan, 30 g of liquid pectin, 0.1 g of CaCl₂, and 1 g of citric acid. The method for making the cup includes combining water and CaCl₂ in a cooking pot and allowing the CaCl₂ to dissolve into the water.

Once the CaCl₂ is dissolved, the sugar is added to the pot and the heat is reduced to medium high. The mixture is continually whisked until the sugar completely dissolves. Once the sugar is fully incorporated, the citric acid is added followed by one-half of the glycerin. Once the solution reaches around 170° F., the agar is added to the liquid slowly, forming a thin coating over the surface of the liquid, and whisked until completely dissolved. The liquid is brought back to a boil and cooked for two minutes and thirty seconds. The heat is then turned off. Liquid pectin is added when the temperature falls to 200° F. The mixture is stirred and the remaining glycerin is added. When the temperature falls to 185° F., the carrageenan is added by starting the immersion blender and then adding the carrageenan and blending until it is smooth and forms a whirlpool motion. When all the carrageenan is in the mixture, the temperature should be between 180° F. and 190° F. To reduce the bubbles, the liquid slowly poured back and forth into another container a few times and then pour through a fine sieve. Finally, the mixture is poured into the mold and allowed to harden.

The liquid pectin as used above is a mixture of water and pectin. The liquid pectin is made using 1 liter of water and 50 grams of pectin. First, the water is heated to 75 degrees Celsius in a pot. Then, the heat is turned off and the pectin is mixed into the water until the mixture is completely homogenous. Finally, the mixture is cooled completely, allowing it to form a gel. During this process, 28 g of water is lost to evaporation due to heating. Therefore, the amount of water in the finished edible cup of this embodiment is 240.6 g.

In yet another embodiment of the present invention, the edible cup is made from about 25% to about 35% water based liquid by weight, about 20% to about 30% sugar by weight, about 33% to about 45% syrup by weight, about 1% to about 3% agar by weight, about 0.0% to about 3% color by weight, and about 0.0% to about 10% flavor by weight. In some embodiments, the sugar content will be reduced and replaced with a larger percentage of syrup which may be a tapioca syrup. The reduction of sugar may be as large as 20% and in other embodiments may be as large as 35% to about 50%. In a preferred embodiment, a reduction of about 25% is employed. Each ingredient may be weighed to a pre-processing weight of about 5558 grams to create a 50-60 edible cup batch. In other embodiments, the formulation is used to create anywhere from about 10 to about 10,000 edible cups per batch.

The method for making the edible cups includes combining the water based liquid and the syrup and placing the syrup solution on a heating element. The heating element is set to a first temperature for a first length of time. The dry ingredients are separately measured and set aside until they are ready to be added to the syrup solution. Once added to the syrup solution, the heated solution is brought to a boil with constant stirring. The solution is then removed from the heat and stirred until a predetermined temperature is reached. Previously, any coloring and/or flavoring was weighed and set aside. Once cooled to the desired temperature after removal from the heat, any coloring and/or flavoring can be added.

Once the resulting product has a homogenous consistency, a first amount of the product can be added to each individual mold. The molds may be clamped and the product is allowed to cure in the mold. The cups are de-molded and then placed in a dehydrator to achieve a desired cup weight (for each individual cup). The cups are removed from the dehydrator and allowed to cool. After which, the inside and outside of the cups are sprayed with an edible coating and allowed to dry for a length of time.

### Molds

Once the edible material has been made, the edible material may be molded into a variety of shapes. In the edible cup embodiment, the edible cups may be molded using a two-part food-grade silicone mold. In other embodiments, the edible cups may be molded using a polycarbonate mold. In yet other embodiments, other materials and molding processes may be utilized in crafting the edible cups. For small scale production, each mold is made by hand using 3D printed pieces that were created using a 3D CAD program. In some embodiments the edible cup may have a glossy, glass-like finish. In such glossy embodiments, a pattern piece may be printed separately and applied to the edible cups to achieve this finish. The molds may comprise at least one and as many as three or more separate parts to be built in a 3D CAD program, such as Solidworks. Typically, the molds may provide for an edible object such as a cup. Such a cup may have a wall thickness of about 1/32″ inches to about 1 inch and more preferably about 1/16″ inches to about ⅜″ inches.

### Dehydration

Dehydration may be a part of the process of making the edible material or an edible object formed of the edible material that helps to reinforce the structural integrity of the material by removing excess water to make the material more durable. Dehydration is typically applied to an edible object once the edible material has been molded into the edible object. In an embodiment of an edible cup, once the cups have been removed from the molds and cooled, the cups are placed onto metal trays and put into a dehydrator to remove excess moisture. The dehydrator may be a convection oven. The cups may be left in the dehydrator for a period of about one hour to about twenty four hours until the containers have a texture that is firm like licorice, but pliable and softer than hard candy.

In one embodiment, an edible cup may have a total weight of about 94-95 grams after the cup has been removed from a mold, and after dehydration, the cup may have a total weight of about 70 grams to about 75 grams, with a net water loss of around 19-21 grams during dehydration or 20-22% of water loss by weight of the edible cup from dehydration. In another embodiment, an edible cup may have a total weight of about 65 grams after the cup has been removed from a mold, and after dehydration, the cup may have a total weight of about 49 grams to about 55, with a net water loss of around 10-16 grams during dehydration or 15-25% of water loss by weight of the edible cup from dehydration. In yet other embodiments, the cup may have a total weight of about 20 grams to about 200 grams.

According to certain embodiments, the water loss due to evaporation and dehydration may be about 5% to about 80% of the pre-process amount of water. According to certain embodiments, the water loss due to evaporation and dehydration may be 60%-80% of the pre-process amount of water. According to certain embodiments, the water loss due to evaporation and dehydration may be 75%-80% of the pre-process amount of water. According to certain embodiments, the water loss due to evaporation and dehydration may be 50%-75% of the pre-process amount of water. According to certain embodiments, the amount of water in an edible object or edible material after dehydration is about 2% to about 20% by weight of the edible cup or edible object. Thus, the final dehydrated cup may, in some embodiments, have a moisture content of about 2% to about 30%. In other embodiments, the moisture content is about 4% to about 20%. In other embodiments, the moisture content is about 10% to about 17% and is preferably 14%. In still other embodiments, the moisture content is about 13% to about 16%. The resulting edible cup may be less sticky and more structurally durable. The same or similar water loss from dehydration may be applied to other embodiments of edible objects formed from an edible material described herein.

### Coating—Continued

Once an edible object has been reinforced through dehydration, it may be coated to make the edible material waterproof and to provide a smooth finish to the final product. Edible objects may be coated with a wax-based, edible coating. The containers may be coated by being sprayed with an edible coating that is used to give the containers a glossy, sheen finish and to reduce stickiness. The coating may also enhance the shelf life of the containers to twelve months without refrigeration.

According to certain embodiments, the coating is applied to the containers through a spraying process. The containers are placed on a spinning flat surface and a hose is used to spray the outside surface of the containers as they are being spun. The inside surface is also coated through spraying. The coated containers are dried with fans for up to twenty-four hours. That coating may add about 0.1 grams to about 2 grams to the overall weight of the edible object and more preferably about 0.2 grams to about 1.2 grams. The edible coating may also allow the edible container to hold hot liquids such as coffee, tea, soups, hot chocolate, and other beverages ranging in temperature from 32 to 180 degrees Fahrenheit. According to certain embodiments, the edible coating enables an edible cup to hold liquids around 160 degrees Fahrenheit for several hours. The coating may be present in thicknesses of about 0.5 mm to about 3 mm and more preferably about 1 mm.

In one embodiment, the edible cup includes a biodegradable sleeve wrapped around the bottom section of the cup, which allows the edible cup to be served without the actual edible cup material being touched. The sleeve wraps around the bottom portion of the cup, and is fastened at the back with a sticker. Both the sleeve and sticker are made from a biodegradable material, which allows the entire cup to be composted. In one embodiment of the sleeve, Grafix Plastics Cellulose Acetate Film in 0.010″ is used, and in one embodiment of the sticker, EarthFirst PLA film is used. In a preferred embodiment, the sleeve is comprised of a paper product or a combination of paper products. Additional materials that may be used for the sleeve include paper, cardboard, wood, cloth, wax, biodegradable plastic, metals, rubbers, silicone, wood veneer, paper pulp, edible materials, colored cellulose leaves, flowers, straw, and other plant matter.

Other embodiments of edible containers are within the scope of the present invention. Such embodiments may be drink ware such as teacups, mugs, stemware, shot glasses, cocktail glasses, lowballs, highballs, flatware such as spoons, knives, forks, and utensils, tableware such as plates, saucers, and bowls, serving ware such as platters, serving bowls, pitchers, and jugs, drink ware accessories such as straws, cup cozies, and coasters, and containers such as jars, bottles, lids, and other food containers.

In one embodiment, the edible material may be used for drink infusions. The edible material may form a dissolvable, edible drop that contains a liquid infusion inside. When the edible drop object is placed in a hot water, the edible drop will dissolve and release flavoring for infusing a drink. Edible drops may be used for infusing hot drinks such as tea, coffee, hot chocolate, or infusing cold drinks such as iced tea, cold brew coffee, juices, soda, flavored water, sparkling flavored water, alcoholic beverages, energy drinks, vitamin drinks, and sports drinks.

The edible drops may also be frozen to form a beverage infusion drop that releases beverage flavoring when the frozen drop melts. In another embodiment, the edible material may be used to form seeds and flower bombs that may contain embedded ingredients. The edible material may also be used as a functional food carrier material for vitamins, energy, and hydration.

Another embodiment of the edible material is an edible film, skin, or shell used to contain a food filling. The edible films, skins and shells may be used to form candy, pastas such as ravioli, dumplings, wontons, mochi, and tortilla skins used to wrap or encase food fillings such as syrups, jellies, ganaches, chocolate, meat, vegetable, cheese, fruit, nut, ice cream, paste, peanut butter, syrup, sugar, and candy. The edible food films, skins and shells used to wrap or encase food fillings may also be frozen to hold frozen ingredients such as ice cream. In another embodiment, the edible material may comprise of an iced casing used to hold flavorings for infusing drinks.

In another embodiment the edible material may be used as an edible material for 3D printing edible objects. The edible material may also be used to form edible clothing in the intimacy industry such as edible lingerie, edible underwear, edible accessories and toys. The concentration of the ingredients used for making the edible material may be adjusted by weight to produce a softer, more pliable material or a harder, more rigid material.

What is claimed is:

1. A composition comprising:
water;
syrup;
sugar; and
one or more hydrocolloids;
wherein the syrup is present in an amount of about 25% to 45% by weight pre-process, the sugar is present in the amount of about 20% to 40% by weight pre-process, and the hydrocolloid is present in the amount of about 1% to 10% by weight pre-process.

2. The composition of claim 1, wherein the hydrocolloid is agar.

3. The composition of claim 1, wherein the syrup is tapioca syrup.

4. The composition of claim 2, wherein the water is present in an amount of about 21% to 34% by weight pre-process, the syrup is present in an amount of about 26% to 42% by weight pre-process, the sugar is present in an amount about 25% to 39% by weight pre-process, and the agar is present in an amount about 2% to 9% by weight pre-process.

5. The composition of claim 1, wherein the composition is an edible container after processing.

6. The composition of claim 5, wherein the edible container further comprises an edible lid and an edible straw.

7. The composition of claim 4, wherein the composition is processed into an edible container capable of holding liquids for up one hour before degrading.

8. The composition of claim 4, wherein the composition is processed into an edible container capable of holding liquids for up to seventy two hours before degrading.

9. The composition of claim 4, wherein the composition is processed into an edible container capable of containing liquid having a temperature of at least 160 degrees Fahrenheit a period of over one hour.

10. The composition of claim 4 wherein the composition is processed into an edible container, and the edible container has a shelf life of up to 12 months without refrigeration.

11. The composition of claim 5, wherein the edible container has a wall thickness less than or equal to about 0.5 inch.

12. The composition of claim 1, further comprising at least one coloring agent.

13. The composition of claim 1, further comprising at least one flavoring agent.

14. A method for making an edible material comprising the steps of:
combining water, syrup, sugar, and one or more hydrocolloids into a mixture; and
processing the mixture into an edible object by:
heating the mixture until the sugar and the hydrocolloids are dissolved;
pouring the mixture into a mold;
cooling the mixture in the mold; and
de-molding the edible object.

15. The method of claim 14 further comprising the step of:
dehydrating the edible object until the water present in the edible object is about 2% to 20% by weight.

16. The method of claim 14 further comprising the step of:
coating the edible object with an edible coating.

17. The method of claim 14, wherein the hydrocolloid is agar.

18. The method of claim 14, wherein the syrup is tapioca syrup.

19. The method of claim 14, further comprising the step of combining at least one coloring agent with the mixture.

20. The method of claim 14, further comprising combining at least one flavoring agent with the mixture.

21. The method of claim 14, wherein the mixture is poured into a mold when a brix rate is about 60 to about 75.

22. The method of claim 16 wherein the edible coating is applied to the edible container by spraying.

23. A composition comprising:
a water-based liquid;
a syrup;
a sugar; and
one or more hydrocolloids;
wherein the syrup is present in an amount of about 30% to about 45% by weight, the sugar is present in the amount of about 20% to about 35% by weight, and the one or more hydrocolloids is present in the amount of about 1% to about 5% by weight.

24. The composition of claim 23 further comprising at least one coloring agent,
wherein the at least one coloring agent is present in the amount of about 0.1% to about 5% by weight.

25. The composition of claim 23 further comprising at least one flavoring agent,
wherein the at least one flavoring agent is present in the amount of about 0.1% to about 10% by weight.

26. The composition of claim 23, wherein the hydrocolloid is agar.

27. The composition of claim 23, wherein the syrup is tapioca syrup.

28. The composition of claim 23, wherein the water-based liquid is present in an amount of about 10% to about 30% by weight.

29. An edible object having the composition of claim 23.
